(19) United States
(12) Patent Application Publication
(10) Pub. No.: US 2006/0188635 A1
(43) Pub. Date: Aug. 24, 2006

(54) Food product comprising phytosterols

(76) Inventors: Robertus Martinus M. Diks, 3133 AT Vlaardingen (NL); Gustaaf Servaas M. J. E Duchateau, 3133 AT Vlaardingen (NL); Johannes Lambertus Zevenbergen, 3133 AT Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/566,427

(22) PCT Filed: Jul. 1, 2004
(86) PCT No.: PCT/EP04/07287

§ 371 Date: Jan. 27, 2006

(30) Foreign Application Priority Data
Jul. 29, 2003 (EP) 03077378.2

(51) Int. Cl. A23D 9/00

(52) U.S. Cl. 426/601

(57) ABSTRACT

The invention relates to a food product comprising β-sitosterol and β-sitostanol, characterized in that the amount of β-sitostanol is from 5 to 12 wt % based on the total weight of β-sitosterol and β-sitostanol.

### FIELD OF THE INVENTION

The invention relates to food products suitable for blood cholesterol lowering which comprise phytosterols.

The invention further relates to food products suitable for lowering triglyceride level in serum.

### BACKGROUND TO THE INVENTION

Phytosterols are well known blood cholesterol-lowering agents. The benefit of these ingredients to reduce the risk to cardiovascular diseases has been established for years.

Phytosterols, also known as plant sterols or vegetable sterols can be classified in three groups, 4-desmethylsterols, 4-monomethylsterols and 4,4′-dimethylsterols. In oils they mainly exist as free sterols and sterol esters of fatty acids although sterol glucosides and acylated sterol glucosides are also present. There are three major phytosterols namely beta-sitosterol, stigmasterol and campesterol. Schematic drawings of the components meant are as given in “Influence of Processing on Sterols of Edible Vegetable Oils”, S. P. Kochhar; Prog. Lipid Res. 22: pp. 161-188.

The respective (5α-) and other saturated derivatives such as sitostanol, campestanol and ergostanol are also effective in lowering total- and LDL cholesterol levels in humans upon daily intake in the range of a few hundred milligrams to several grams per day (Hallikainen, M. A. et al; European Journal of Clinical Nutrition; 2000, vol54 no 9, p 715-725; Westrate J. A. et al; Journal of Clinical Nutrition 1999 vol 53 no 4, p 319-327). Whereas this cholesterol lowering effect is hypothesized to be based on the structural similarity with cholesterol, and hence interference with intestinal cholesterol absorption, plant sterols and stanols are hardly absorbed themselves. The absorption relative to cholesterol (absorption range 30-70%, average 50%) is about 1 to 5% for sterols and about 0.1 to 2% for stanols (Heinemann T. et al; European Journal of Clinical Investigation; 1993 vol 23 no 12 page 827-831).

Mensink, R. P et al. disclose in Atherosclerosis volume 160, issue 1 January 2002, pages 205-213 that yoghurt supplemented with plant stanol esters lowered the intestinal absorption of cholesterol, as indicated by the decreases in cholesterol-standardized sitosterol and campesterol concentrations.

WO-A-98/01759 discloses that β-sitostanol inhibits the absorption of phytosterols as well as cholesterol in the bloodstream. It is mentioned that it is possible that the presence of sitostanol selectively inhibits the absorption or facilitates the elimination of sitosterol relative to campesterol. A cholesterol lowering composition is presented which comprises in a preferred form 10-25 wt % campesterol, 10-15% stigmastanol (β-sitostanol) and from 45-75 wt % (β-sitosterol. These compositions allegedly are most suitable for increasing the campesterol to β-sitosterol ratio which is an indication for a person's health. A high ratio is a positive health indication.

WO-A-00/61771 discloses transgenic plants, seeds of which contain elevated levels of sitostanol and/or sitostanol esters and alpha tocopherol. Examples are provided of seeds comprising elevated levels of stigmastanol.

Atta M. B. Journal of oleo science, vol 51 no 7, 2002, pages 457-461, discloses the sterol composition of crude oil extracts from roselle seeds, compared with corn oil.

Venkatramesh, M; Phytochemistry vol 62, 2003, pages 39-46 discloses the phytosterol and phytostanol content of transgenic oil seeds from rapeseed and soy bean. It is suggested that phytostanols are more effective than phytosterols in lowering cholesterol and that the intestinal absorption of phytostanols is lower than of phytosterols.

Sanders D. J. et al; Food and Chemical toxicology, vol 38, 2000, pages 485-491 provides a safety evaluation of phytosterol esters. It is concluded that of the phytosterols, campesterol was absorbed more than beta-sitosterol and stigmasterol which were absorbed slightly more than campestanol and beta-sitostanol.

The food compositions known from the cited art rely on relatively high levels of β-sitostanol with a general minimum of around 16 wt % on total β-sitostanol and β-sitosterol present in a dietary product.

The prior art further discloses compositions suitable for lowering triglyceride levels in blood serum. EP-A-1004594 discloses use of a composition of phytosterol/stanol esters with polyunsaturated fatty acids of C18-C22 and at least 3 unsaturated carbon-carbon bonds for preparing a formulation or food ingredient for the purpose of lowering serum cholesterol and simultaneously lowering serum triglycerides. These specific esters have as a disadvantage that they are susceptible to off flavour development due to oxidation of the double carbon-carbon bonds.

We have surprisingly found that at a specific ratio of β-sitostanol to β-sitosterol, an optimum is reached in cholesterol lowering effect and reduction of uptake of β-sitosterol in blood. This particularly beneficial combination of β-sitosterol and β-sitostanol is of interest to consumer products. It is of special interest to patients suffering sitosterolemia.

Also we have surprisingly found that at the same specific ratio of β-sitostanol to β-sitosterol which gives a cholesterol lowering effect, an optimum is reached in plasma triglyceride lowering effect. This particularly beneficial combination of β-sitostanol and β-sitosterol is of interest for consumer products. It is of special interest to individuals who are suffering hypertriglyceremia.

### SUMMARY OF THE INVENTION

The present invention relates to a food product comprising an aqueous phase, said product comprising β-sitosterol and β-sitostanol, wherein the amount of β-sitostanol is from 5 to 12 wt %, preferably 5 to 10 wt % based on the total weight of β-sitosterol and β-sitostanol.

The invention further relates to food products for lowering the uptake of β-sitosterol in blood and to a method for preparing a formulation for use in lowering the uptake of β-sitosterol in blood wherein a composition comprising β-sitosterol and β-sitostanol, wherein the amount of βP-sitostanol is from 5 to 12 wt % based on the total weight of β-sitosterol and β-sitostanol is used.

The invention also relates to a method for preparing a formulation for use in the reduction of total triglyceride levels in blood, wherein a composition comprising β-sitosterol and β-sitostanol, wherein the amount of β-sitostanol is from 5 to 12 wt % based on the total weight of β-sitosterol and β-sitostanol is used.

### DETAILED DESCRIPTION

Where a percentage is used, this relates to wt % unless other wise is indicated.

In the context of the invention, the terms “oil” and “fat” are used interchangeably.

The food products according to the invention comprise an aqueous phase. This implies that at least some water is present. In a preferred embodiment the food products comprise at least 10 wt % water on total product weight.

In the context of the invention the term phytosterol refers to sterols and to the saturated equivalents, stanols, or phytostanols. The term phytosterol also covers derivatives such as phystosterolesters, especially esters of phytosterols and fatty acids such as those disclosed in WO-A-98/19556. In the context of the invention a specific distinction is made between β-sitosterol and β-sitostanol, the 5-alpha saturated derivative of beta sitosterol.

The invention relates to a food product comprising β-sitosterol and β-sitostanol, wherein the amount of β-sitostanol is from 5 to 10 wt % based on the total weight of β-sitosterol and β-sitostanol. The individual amounts of β-sitosterol and β-sitostanol are based on their free, i.e. non modified compounds. Hence the weight of e.g. a fatty acid group esterified to the sterol or stanol is not part of the calculation.

In a preferred embodiment, the amount of β-sitostanol is from 6 to 9 wt %, preferably from 6.5 to 8.5 wt %, more preferred from 7 to 8.5 wt % based on the total weight of β-sitosterol and β-sitostanol. It was found that within these ranges the level of β-sitosterol in blood is reduced most effectively.

In a preferred embodiment the invention relates to a food product wherein the β-sitosterol and β-sitostanol are at least partly esterified to fatty acids. The esterification generally increases the fat solubility of the phytosterols. Commercial products such as Becel pro-activ™, and Benecol™ comprise sterol fatty acid esters and stanol fatty acid esters respectively.

Preferably the phytosterols, especially β-sitosterol and β-sitostanol, are esterified with one or more C₂₋₂₂ fatty acids. For the purpose of the invention the term C₂₋₂₂ fatty acid refers to any molecule comprising a C₂₋₂₂ main alkyl chain and at least one carboxylic acid group. Although not preferred within the present context the C₂₋₂₂ main chain may be partially substituted or side chains may be present. Preferably, however the C₂₋₂₂ fatty acids are linear molecules comprising one or two carboxylic acid group(s) as end group(s). Most preferred are linear C₈₋₂₂ fatty acids as occur in natural oils.

Suitable examples of any such fatty acids are acetic acid, propionic acid, butyric acid, caproic acid, caprylic acid, capric acid. Other suitable acids are for example citric acid, lactic acid, oxalic acid and maleic acid. Most preferred are lauric acid, palmitic acid, stearic acid, arachidic acid, behenic acid, oleic acid, cetoleic acid, erucic acid, elaidic acid, linoleic acid and linolenic acid.

When desired a mixture of fatty acids may be used for esterification of the sterols. For example, it is possible to use a naturally occurring fat or oil as a source of the fatty acid and to carry out the esterification via an esterification reaction optionally using the oil as a solvent.

In a particular embodiment, the fatty acid mixture contains a high amount (>35%, preferably >45%, further preferred >60%) of polyunsaturated fatty acids (PUFA). This does not only provide the advantage of PUFA itself having good blood cholesterol lowering capacity, but also of the sterols esters prepared with such fatty acids being considered as having a higher solubility and blood cholesterol lowering efficacy in the body.

Preferably fatty acid mixtures of sunflower, safflower, rapeseed, linseed, linola and/or soybean are used. These are typical sources of high PUFA and/or low SAFA (saturated fatty acids). Suitable esterification conditions are for example described in WO-A-92/19640.

In selecting the suitable fatty acids for esterification it is preferred that high levels of fatty acids derived from fish oil are avoided because these are susceptible to off flavour development.

Suitable sources of phytosterols are for example soy bean, wood pulp, rapeseed oil. It is preferred that the phytosterol composition in the food product is derived from a mixture of rapeseed oil and wood pulp.

In addition to the phytosterols mentioned above (β-sitostanol and β-sitosterol), the food product optionally comprises other phytosterols such as those selected from the group comprising campesterol, campestanol, brassicasterol, stigmasterol, stigmastanol or a combination thereof. Optionally these are also esterified to fatty acids or other compounds. Food products comprising up to 1 wt % campestanol, preferably from 0.7 to 1 wt % campestanol based on the total weight of the phytosterols in the food product are preferred because they result in low total phytosterol blood serum levels.

In particular it was found that food products wherein the amount of β-sitosterol is from 45 to 90 wt %, preferably from 50 to 90 wt %, more preferred from 70 to 90 wt % on the total weight of all phytosterols in the food product are very suitable dietary compounds.

Examples of suitable food products include emulsions such as milk, margarine, yoghurt, creamer; bars, and drinks such as juices. Most suitable are food products that are consumed on a regular, daily basis in more or less constant amounts per day. Therefore margarine, milk, yoghurt and juices are considered very suitable whereas e.g. ice cream, creamer and bars are generally less suitable for inclusion of the phytosterol ingredients according to the invention.

Preferred products therefore are milk, juices, yoghurt, margarine or other spreadable emulsion type products.

In the context of the invention products comprising a fat phase and phytosterols and optionally other ingredients but no water, are not encompassed by the term food product.

It was further found that the blood cholesterol lowering effect of the claimed combination of β-sitostanol and β-sitosterol is improved in the presence of at least some fat. Therefore it is preferred that some fat is present in the gastrointestinal tract to improve the blood cholesterol lowering effect. According to one embodiment, the fat is part of the food product to which the β-sitostanol and β-sitosterol have been added. More preferred the food product comprises at least 10 molecules of fat (triglyceride) on each phytosterol molecule. Optionally the food product comprises from 0.1 to 80 wt %, even more preferred from 0.5 to 50 wt % fat.

According to another embodiment the food product comprising β-sitostanol and β-sitosterol is essentially fat free. In this embodiment, the food product is preferably accompanied by instructions that simultaneous intake of at least some fat is preferred. Such instructions may be part of the packaging material of the food product or they may be included on a separate leaflet.

In the context of the invention the term fat especially refers to triglycerides. The fat is preferably selected from the group comprising butter fat and vegetable oils e.g. sunflower oil, corn oil, rapeseed oil, olive oil, safflower oil, linseed oil, soy bean oil or a combination thereof.

It will be appreciated that the total amount of phytosterol in a food product may be dependent on the type of food product and the average consumption pattern for such product.

The preferred amount is such that the average total daily intake for a consumer taking the usual amounts of the product is from 1.6 g to 5 g free phytosterol per day, preferably 2 to 3.5 g free phytosterol per day. Hence it will be appreciated that the amount included in a food product may be dependent on the serving size of the product concerned.

The amount of phytosterol in the food product is determined in terms of free sterol or stanol. This means the amount of the sterol or stanol composition without taking into account the chemical modifications such as esterification, which in effect lead to an increase of the weight of an individual molecule.

Hence, preferred products are those wherein the total weight of phytosterols is from 0.5 to 15 wt %, preferably from 1 to 10 wt % free phytosterols based on the total weight of the food product.

For improvement of taste and to impart nutritional value, the food product optionally comprises a protein. Said protein can be of vegetable or dairy origin whereby dairy origin is preferred.

Dairy proteins are suitably selected from sources such as milk protein, whey protein, skim milk powder, whey powder, sweet whey (powder), buttermilk or butter milk powder or a combination thereof. The amount of such protein is for example from 0.2 to 3, preferably from 0.5 to 2 wt % on total product weight.

Furthermore the food products optionally comprise other benefit agents such as vitamins, anti-oxidants.

Optionally the food products comprise common ingredients such as flavouring ingredients, colouring agents, thickeners, herbs and the like.

The products are produced in a well-known manner. The phytosterol composition may be included at any stage in the process.

In a further aspect the invention relates to a food product comprising β-sitosterol and a small amount of β-sitostanol for use in reducing the absorption of β-sitosterol in blood. A small amount is preferably from 5 to 12 wt % on total weight of β-sitosterol and β-sitostanol.

In a preferred aspect the invention relates to a method for preparing a formulation for use in lowering the uptake of β-sitosterol in blood wherein a composition comprising β-sitosterol and β-sitostanol, wherein the amount of β-sitostanol is from 5 to 12 wt % based on the total weight of β-sitosterol and β-sitostanol is used.

In a further aspect the invention relates to a method for preparing a formulation for use in the reduction of total triglyceride levels in blood, wherein a composition comprising β-sitosterol and β-sitostanol, wherein the amount of β-sitostanol is from 5 to 12 wt % based on the total weight of β-sitosterol and β-sitostanol is used.

The formulations referred to are preferably food products as presented in more detail above. Alternatively the formulation is a medicament.

The invention is now illustrated in the following non-limiting examples.

### EXAMPLES

### Example 1

A spreadable water in oil emulsion with 47% fat (triglycerides only) was prepared with the following ingredients:

| | |
|---|---|
| Oil blend (partially hardened) rapeseed oil, sunflower oil, | 47% |
| palm kernel oil and palm oil | |
| Phytosterol composition | 13.9% |
| Mono/diglycerides | 0.3% |
| Water | up to 100% |
| Whey powder | 0.4% |
| Potassium sorbate | 0.14% |
| Alginate | 0.3% |
| Maltodextrin | 3.0% |
| Citric acid | 0.2% |
| Beta-carotene | 0.0028% |

Monoglycerides, phytosterol composition and sunflower oil are mixed and heated up to 50° C. After cooling down to 30° C., pre-crystallized fully hydrogenated high erucic rapeseed oil (8% w/w) in a powder form is added to the fat phase while gently stirring. After obtaining a homogeneous slurry, the water phase is added to the fat phase while agitating with an Ultra-Turrax homogenizer at 12,900 rpm for 10 minutes. All concentrations are related to the total composition of the emulsion. The resulting emulsion is filled into tubs and stored at 5° C.

The phytosterol composition of the products was as follows:

| | Wt % on total |
|---|---|
| | phytosterol |
| ingredient | composition |
| Cholesterol | 0.1 |
| Brassicasterol | 4.4 |
| Campesterol | 23.1 |
| Campestanol | 0.6 |
| Stigmasterol | 0.7 |
| β-sitosterol | 63.5 |
| β-sitostanol | 4.4 |
| Delta-avenasterol | 1.4 |
| other | Up to 100% |

The amount of β-sitostanol on total weight of β-sitostanol and β-sitosterol for this example is 6.4 wt %.

The above described product, containing the plant sterols/stanol combination was dosed at 1600 mg/day (sum sterols+stanols, as their esters) for 3 weeks to normal to mildly hypercholesterolemic subjects (n=40). It was found that after 3 weeks of use the decrease for plasma total cholesterol was −9.6% and for plasma LDL-cholesterol −11.4% (relative to control). Increasing the dose to 3000 mg/day for 3 additional weeks increased the effect; data were now for plasma total cholesterol −11.2%; and for plasma LDL-cholesterol −14.7%. These data are all relative to matching subjects (n=40) receiving control product.

Interestingly, in this study, a significant lowering effect on plasma TG levels was observed; after 3 weeks the decrease was −17.4% and after 3 more weeks at the higher dose −21.5%. TG changes in the control group were not significant from baseline. No changes were observed in the liver function test over time, dose or treatment groups.

1. Food product comprising an aqueous phase, said product comprising β-sitosterol and β-sitostanol, characterised in that the amount of β-sitostanol is from 5 to 10 wt % based on the total weight of β-sitosterol and β-sitostanol.

2. Food product according to claim 1 wherein the amount of β-sitostanol is from 6 to 9 wt %, preferably from 6.5 to 8.5, more preferred from 7 to 8.5 wt % based on the total weight of β-sitosterol and β-sitostanol.

3. Food product according to claim 1 wherein the β-sitosterol and β-sitostanol are at least partly esterified to fatty acids.

4. Food product according to claim 1 which additionally comprises up to 1 wt % campestanol, preferably from 0.7 to 1 wt % campestanol based on the total weight of the phytosterols in the food product.

5. Food product according to claim 1 wherein the amount of β-sitosterol is from 45 to 90 wt %, preferably from 50 to 90 wt %, more preferred from 70 to 90 wt % on the total weight of all phytosterols in the food product.

6. Food product according to claim 1, wherein the total weight of phytosterols is from 0.5 to 15 wt %, preferably from 1 to 10 wt % free phytosterols based on the total weight of the food product.

7. Food product according to claim 1, which is selected from the group comprising milk, yoghurt, margarine, and juices.

8. Food product according to claim 1, which comprises fat, preferably at a level of at least 10 triglyceride molecules per phytosterol molecule.

9. Food product comprising β-sitosterol and a small amount of β-sitostanol for use in reducing the absorption of β-sitosterol in blood.

10. Method for preparing a formulation for use in lowering the uptake of β-sitosterol in blood wherein a composition comprising β-sitosterol and β-sitostanol, wherein the amount of β-sitostanol is from 5 to 12 wt % based on the total weight of β-sitosterol and β-sitostanol, is used.

11. Method for preparing a formulation for use in the reduction of total triglyceride levels in blood, wherein a composition comprising β-sitosterol and β-sitostanol, wherein the amount of β-sitostanol is from 5 to 12 wt % based on the total weight of β-sitosterol and β-sitostanol, is used.
